(19) United States
(12) Patent Application Publication
(10) Pub. No.: US 2009/0183350 A1
(43) Pub. Date: Jul. 23, 2009

(54) Method for Ultrasound Probe Repair

(75) Inventors: Dennis Wulf, Broken Arrow, OK (US); Larry Busse, Cincinnati, OH (US); Jay Manuel, Tulsa, OK (US); Larry Hill, Tulsa, OK (US)

Correspondence Address: DOERNER SAUNDERS DANIEL & ANDERSON, LLP, 320 South Boston, Suite 500, Tulsa, OK, 74103-3725, US

(73) Assignee: Wetsco, Inc., Tulsa, OK (US)

(21) Appl. No.: 12/353,627

(22) Filed: Jan. 14, 2009

Related U.S. Application Data
(60) Provisional application No. 61/021,730, filed on Jan. 17, 2008.

(51) Int. Cl. B23P 6/00

(52) U.S. Cl. 29/402.08

(57) ABSTRACT

Methods, systems, and devices are provided for the repair of a monolithic array comprised of elements. The method includes processes to identify damaged sections containing damaged elements in a damaged array, where each section contains contiguous elements with at least one damaged element; identify good sections in donor arrays that contain at least as many contiguous elements as those in each corresponding damaged section; removing the damaged sections from the damaged array; removing the good sections from the donor arrays; preparing the damaged array to receive the good sections; affixing the good sections to the damaged array; and testing the damaged array to ensure its characteristics are the same as those of an undamaged array.

### BACKGROUND OF THE DISCLOSURE

The present disclosure generally relates to methods and devices for the repair of ultrasound probes used in medical and industrial applications.

Ultrasound techniques are commonly used in a variety of medical specialties such as obstetrics, gynecology, radiology, cardiology, and surgery. They are commonly used in the medical field to perform a variety of useful functions, such as diagnosis of cardiovascular disease, classifying lesions as being malignant or benign, guiding biopsy procedures, and clarifying a variety of conditions effecting pregnant women and their fetuses. In industry, ultrasound techniques are used to perform nondestructive testing, the purpose of which is to detect defects that may occur either during the manufacturing process or after a part has been used (such as fatigue cracks, stress corrosion cracks, or simple corrosion). Such tests are typically performed in the aviation, transportation, and energy generation industries.

An ultrasound probe is generally used to generate and detect acoustic waves. Such probes may be either handheld or mounted on fixed or moving platforms, but they all are comprised of a regular arrangement of multiple ultrasound transducers, commonly referred to as an array. The array contains many individual transducers (128 or 256 or more) aligned in a regular pattern; each transducer has individual circuitry and leads constituting an element of the array. The arrays are commonly referred to as 2D arrays, 1.5D arrays, linear arrays, curvilinear arrays, and phased arrays, depending upon the geometric arrangement of the elements in the array. The active portion of the transducer is a piezoelectric material, which may be comprised of a ceramic such as PZT (lead-zirconate-titanate) or a single crystal such as PMN-PT (lead-magnesium-niobate/lead-titanate). Acoustic matching layers are also included as parts of the array element to improve the transducer efficiency and bandwidth by better matching the high acoustic impedance of the hard, dense ceramic to the relatively low acoustic impedance of tissue.

Ultrasound probes are highly sensitive instruments that can be easily damaged. For example, a technician may accidentally drop the probe during use or strike the probe against an examination table or other hard surface. The probe may also be damaged if it is improperly stored or transported. Finally, the probe may be damaged if chemicals that are used while the probe is being applied, cleaned, or disinfected are not chosen properly or used incorrectly. Some types of damage to the probe, such as damage to the cable or cracks in the probe's protective casing, can be readily repaired.

However, the transducer array, sometimes referred to as the acoustic stack, is very difficult to repair. Removal of a damaged element or elements involves very precise control of the removal tools in order to prevent further damage to adjacent good elements. Furthermore, the damaged element or elements must be removed in such a way as to prevent misalignment of adjacent good elements by the weakening of the backing, or substrate, upon which all the elements are supported, as by undercutting, frictional melting, and the like. New elements replacing the damaged elements must be very precisely placed back into position. When the new elements are in place, they must be precisely aligned with the other elements in the array. All these operations require very sophisticated and precise techniques performed either by highly trained personnel or by expensive computerized numerical control (CNC) machines that are precisely aligned relative to the damaged elements or to the remaining good elements. Such repair could be performed by the original equipment manufacturer in order to obtain a ready supply of form/fit/function replacement parts. However, when the life cycle costs of such repair are considered, it may be more cost effective for the original equipment manufacturer to simply replace the array in its entirety.

Therefore, since damaged elements are small and difficult to work with, it is difficult to replace them individually leading to the entire acoustic stack being generally discarded. This may be an expensive proposition because the probes themselves are quite expensive.

As can be seen, there is a need for a method to inexpensively repair a probe in a cost effective manner, so that non-catastrophic damage that may degrade the performance of the probe does not result in a replacement of the transducer array, thereby extending the operational life of the probe. Thus, repair of damaged probes is a paramount economic issue for commercial concerns that use such probes on a regular basis. There are approximately 250,000 ultrasound probes in use today in the United States. Probes have an average lifetime of three years. This means that 80,000 probes require repair or replacement each year. The average repair or exchange price of a probe may range from about $3,500 to about $20,000 at current prices. If a method were provided to repair probes having non-catastrophic damage, a significant portion of these costs could be saved.

### SUMMARY OF THE DISCLOSURE

A method is provided for the repair of a damaged array containing elements. The method comprises the following steps, which may not be performed in this order: identifying a first section of elements in the damaged array, wherein the damaged section contains a first number of contiguous elements and all damaged elements in the damaged array are in the first section; identifying a second section in a donor array, the second section having a second number of contiguous good elements that is not less than the first number; removing the first section from the damaged array to leave a repair site within the damaged array; removing the second section from the donor array; and affixing the second section to the repair site of the damaged array.

A method is further provided for the repair of a damaged array containing elements. The method comprises the following steps, which may not be performed in this order: determining a first section of the damaged array within which all of the damaged elements may be located; removing the first section of the damaged array to create a repair site; providing a donor array; identifying a second section of the donor array having a number of undamaged elements equal to the number of damaged elements contained in the first section of the damaged array; removing the second section from the donor array; preparing the second section from the donor array to have a profile that mates to the profile of the repair site; attaching the second section from the donor array to the damaged array at the repair site; aligning the elements of the second section with the remaining elements in the damaged array; repairing electrical connections between the second section and the damaged array; and testing the array for proper operation.

A repaired acoustic array is further provided. The repaired acoustic array comprises good elements from a damaged array and a donor array and may be produced by the previously described methods.

A method is further provided for the partial repair of a damaged ultrasound array. The method comprises the following steps, which may not be performed in this order: identifying a first section of elements in the damaged array, wherein the first section contains a first number of contiguous elements and all damaged elements in the damaged array are in the first section; identifying a second section in a donor array, the second section having a sufficient number of good elements to make the damaged array operable and useful; removing the first section from the damaged array to leave one or more repair sites within the damaged array; removing the second section from the donor array; and affixing the second section to the repair site of the damaged array.

These and other features, aspects, and advantages set forth in the present disclosure will become better understood with reference to the following drawings, description, and claims.

### BRIEF DESCRIPTION OF THE DRAWINGS

FIG. 1 shows a schematic of a typical acoustic stack, according to an embodiment disclosed herein;

FIG. 2 shows a sequence of steps for the generic repair of an acoustic stack when the flexes have been removed, according to an embodiment disclosed herein;

FIG. 3 shows a sequence of steps for the generic repair of an acoustic stack when the flexes remain substantially in place, according to an embodiment disclosed herein;

FIG. 4 shows a cut away drawing of a generic probe, according to an embodiment disclosed herein; and

FIG. 5 shows a flowchart of the repair process, according to an embodiment disclosed herein.

### DETAILED DESCRIPTION

The following detailed description is of the best currently contemplated modes of carrying out the methods set forth in the present disclosure. The description is not to be taken in a limiting sense, but is made merely for the purpose of illustrating the general principles of the methods disclosed herein, since the scope of the present disclosure is best defined by the appended claims.

Broadly, the current disclosure includes methods for replacing a damaged section of elements in an array stack (the recipient array) with a good section of elements taken from a donor array stack, where the good section of elements generally conforms in size and shape to the damaged section. The disclosure includes methods for aligning the donated array section with the recipient array in the areas of mechanical attachment, electrical attachment, and overall performance. In practice, the good section of elements may preferably be taken from a donor array manufactured by the same manufacturer as the recipient array so that the electrical characteristics, material properties, acoustic properties, and general construction readily conform to that of the receiving array.

The recipient array may have one or more damaged sections therein so that it either does not function at all or else it functions at a degraded level. The term “degraded” is taken to mean that some elements may function normally and some elements may not perform according to the specifications of a normal element, so that the overall performance characteristics of the overall array do not match those of a standard array as it comes from the factory. Each damaged section is identified as a section of contiguous elements in the array which may in turn contain one or more damaged elements. The damaged elements may be adjacent to one another or may have intervening good array elements therebetween. In principle, it is desirable to minimize the number of damaged sections by judicious choice of the damaged and good elements for inclusion in the identification of a damaged section. If the number of damaged sections is minimal, then the probability of having to rework the array due to an improper repair is minimized. However, any number of damaged sections may be identified without departing from the scope of the present disclosure.

Also disclosed herein are methods that generally provide for removing a section of contiguous elements from the recipient array, where the removed section contains damaged elements (and therefore a damaged section); selecting a section of contiguous elements from a donor array, where the donated section contains a sufficient number of good elements to make the array functional; and inserting the donated section from the donor array into the gap left by the removed section in the recipient array. The present disclosure also includes methods for aligning, testing, and verifying the repaired array to ensure that it exhibits the same electrical, acoustic, and physical characteristics as a generic array manufactured by the original equipment manufacturer.

Use of the disclosed methods may permit damaged arrays to be repaired without incurring the cost of a new replacement array and discarding the old array. The probe may thus be kept in operational condition for several years in a relatively inexpensive manner. In addition, parts of expensive damaged arrays may be recycled by re-using them as donor arrays whenever it becomes uneconomical to repair them using the disclosed method, in order to provide contiguous operational portions for other damaged arrays. The donor array may also be used to repair multiple recipient arrays, as well as repair other damaged parts of recipient probes, such as cables and connectors. This may reduce waste and the unnecessary manufacture of replacement array parts.

While the disclosed method may be described in terms of repairing an acoustic stack for an ultrasound probe, it may be used in the repair of similar, array-like structures in which small elements, typically on the order of 100-500 microns, are supported on a substrate in a monolithic or unitary arrangement, without departing from the scope of the present disclosure. In the detailed description that follows, it should be understood that although the discussion will focus on the repair of a single damaged section of an array, the disclosed method may be used for the repair of any number of damaged sections in an array without departing from the scope of the present disclosure.

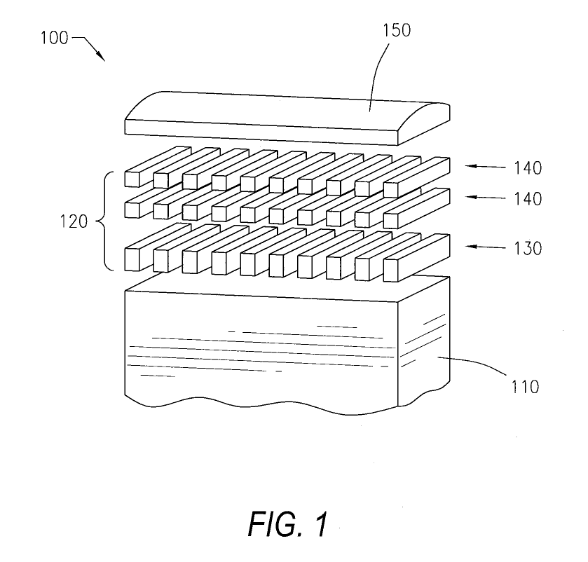

Referring to FIG. 1, a typical acoustic stack 100 is shown in exploded view. The acoustic stack 100 may comprise a backing 110 (or matrix) to support the array elements 120. The backing material may be composed of a rigid acoustic damping material such as, for example, tungsten doped epoxy. The backing material may increase the amount of acoustic energy emitted through the lens 150 and may provide mechanical stability to the array. The acoustic stack 100 may also comprise one or more array elements 120 that perform the intended functions of the array. The array elements 120 may be positioned in a given arrangement on the backing 110, which rigidly maintains the array elements 120 in a fixed alignment and relationship with an enclosing structure and with one another. Each array element 120 may be further comprised of a piezoelectric crystal 130 and one or more matching layers 140. A kerf filler may be present between the array elements 120 in order to decrease the electrical and acoustic interference between the array elements 120. The piezoelectric crystal 130 may be fabricated of a ceramic such as PZT or of a single crystal material such as PMN-PT. The matching layers 140 overlaying the piezoelectric crystal 130 may be present to improve the efficiency and bandwidth of the piezoelectric crystal 130. For example, when the acoustic stack 100 is used for ultrasound investigation of human tissue, the matching layers 140 may provide for better matching of the high acoustic impedance of the hard, dense ceramic to the relatively low acoustic impedance of living tissue. Matching layers 140 may be used for other purposes, depending upon the use to which the acoustic stack 100 is applied. Instead of being passive, the matching layers 140 may also be active, with electrodes for power, shielding, and/or signals, depending upon the application. Although FIG. 1 shows an acoustic stack 100 having two matching layers 140, any number of matching layers 140 may be present without departing from the scope of the present disclosure. Overlaying the entire structure of array elements 120 may be a silicone or urethane lens 150 to focus the ultrasound beam. In addition, the lens 150 may protect the array elements 120 from mechanical damage and misalignment. A shield may also be interposed between the topmost matching layer 140 and the lens 150. When the acoustic stack 100 is in its finished form, it is considered to be a monolithic assembly.

Although the acoustic stack is shown in FIG. 1 for discussion purposes as a linear arrangement of single elements, the acoustic stack may have a shape in which the array elements are linearly aligned along a profile that is either planar (as shown) or curved. Additionally, the array elements may be aligned along a two-dimensional grid, where the grid may also be either planar or curved. The array elements may also be cut and ground in different ways, e.g. they may be cylindrical instead of rectangular (as shown). The elements may also vary in size as well as shape within the same transducer.

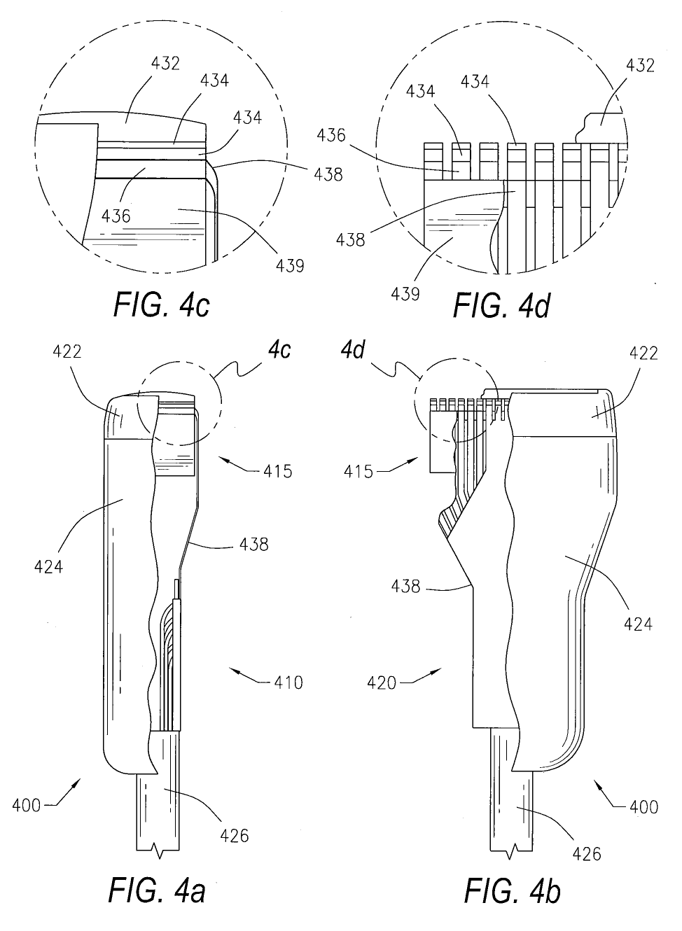

Each element may have leads for connection to an external system that may be used to control the operation of the elements and to detect signals that may be provided by the elements. The elements may be independent, in the sense that they may be individually activated, or fired, in various time sequences and various power levels, according to the particular application. Furthermore, the signals that the elements may provide may be received, weighted, and analyzed according to different algorithms. The leads from the piezoelectric crystals may be attached to flex circuits, or “flexes,” which may consist of individual traces on flexible circuit boards that conduct signals to and from the piezoelectric crystals to external systems (FIG. 4).

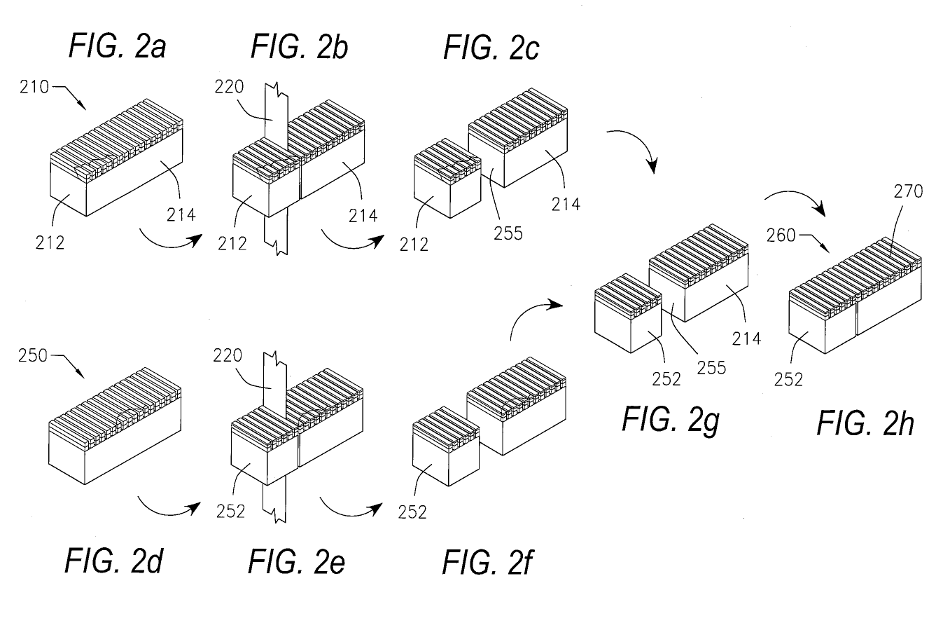

Referring now to FIG. 2, the disclosed repair method may be illustrated in general, according to an embodiment disclosed herein. Generally, a damaged array, i.e. the recipient array, may contain one or more elements that no longer function properly. In practice, these damaged elements are located in adjacent locations, but may theoretically be located anywhere in the array without limitation. A section of the array may be defined as a set of one or more contiguous elements of the array. Sections may be chosen so that a first set of one or more non-overlapping sections include all the damaged elements in the array and a second set of one or more non-overlapping sections include only good elements. As shown by jagged lines in FIG. 2a, the damaged elements may be shown to be a group of elements located on the end of the recipient array 210, for example. These damaged elements may be included in a single section 212 chosen on the end of the array so that the first set contains the single section 212. The second set may also consist of a single undamaged section 214 which is the remainder of the recipient array 210. Note that the first set and the second set are mutually exclusive, by definition. Note also that the damaged section may also contain undamaged elements in addition to the damaged elements, without limitation and without departing from the scope of the present disclosure.

In order to repair the recipient array 210, the section containing the damaged elements must be removed and replaced by a section containing good elements. While it is ideal to always replace a damaged section with a section containing only good elements, it is also possible to replace a damaged section with a section containing a sufficient number of good elements to make the probe operable and useful (i.e., partial repair).

According to FIG. 2b, the section 212 of the recipient array 210 that is removed may contain one or more defective elements that are contiguous, contiguous defective elements along with one or more good elements, defective elements having one or more good elements therebetween, or any combination of defective elements and good elements. Good elements may be removed along with defective elements in an effort to minimize the number of sections that are replaced. As a practical matter, the number and identification of removed sections comprising the first set may be a matter of judgment, and the number of removed sections may be chosen in an effort to maximize the use of materials provided by a donor array or multiple donor arrays, and/or to minimize the number of replacement operations that are performed. Although subsequent descriptions will describe the replacement of a single section for brevity, the removal of multiple sections each containing various combinations of good and defective elements may be considered as within the scope of the disclosed method.

Referring again to FIG. 2b and FIG. 2c, the damaged section 212 may be removed from the recipient array 210, leaving a gap, a hole, or in general a portion of the recipient array 210 that lacks array elements. The removal of damaged sections 212 from the recipient array 210 may be accomplished by a number of methods and tools, including cutting, sawing, machining, milling, grinding, and the like, or any combination thereof. The tools used for such removal may be controlled either manually or by a CNC machine. Tools employed to effect the removal may, for example, be lasers, cut-off wheels, abrasive disks, wire saws, mechanical saws, band saws, water cutting mechanisms, and the like. Note that such a removal operation, depending upon the tool and the technique of removal, may damage good elements in the undamaged section 214 of the recipient array 210 that is adjacent to the kerf made by the removal tool 220.

Referring now to FIG. 2d, a donor array 250 may then be chosen having the same profile, size and shape as the recipient array 210; in other words, it may have the same profile and configuration as the recipient array 210. In practice, the donor array 250 may be an array manufactured by the same manufacturer as that of the recipient array 210, but in theory any such array may be used as long as it has the same operational and physical characteristics as those of the recipient array 210. The donor array 250 may also be chosen to have at least the same number of contiguous good elements as that of the damaged section 212 of the recipient array 210. That number may include good elements that were not electrically connected in the donor array.

As shown in FIG. 2e and FIG. 2f, the good section 252 from the donor array 250 may be removed in a manner similar to that used with the recipient array 210, i.e.; by cutting, sawing, machining, milling, grinding, and the like, or any combination thereof. As before, the tools 220 used for removing the good section 252 may be controlled either manually or by a CNC machine. It is important to ensure that the good section 252 from the donor array 250 replacing the damaged section 212 of the recipient array 210 has at least the same number of elements as the number of elements in the removed section of the recipient array, in addition to a number of elements that is at least the number of elements damaged by the removal operation for the recipient array 210. Although the donor section 252 is shown to be positioned at an end of the donor array 250, the donor section 252 may be at any location within the donor array 250 and still be within the scope of the present disclosure. The rationale for this consideration may be seen presently.

Referring now to FIG. 2g and FIG. 2h, the good section 252 may then be installed into the recipient array 210 to provide a repaired array 260. The repair site 255 where the damaged section 212 was removed may be prepared to receive the good section 252 by shaping the repair site 255 in a uniform manner and then by shaping the good section 252 to generally conform to the shape of the repair site 255. To do this, the repair site 255 may be smoothed as by grinding or milling to render the surface of the repair site 255 free from any irregularities. Also, any elements adjacent to the repair site 255 which might have been damaged by the removal process may be themselves removed so that a regular surface is presented to mate with the good section 252. The good section 252 may be prepared in a similar manner, so that it may conform to and mate with the repair site 255. This preparation may be accomplished by milling, grinding, or any other suitable technique.

When the surfaces of both the repair site 255 and the good section 252 are suitably prepared, the good section 252 may be installed within the repair site 255 as by epoxy, gluing, welding, heat treatment, or other similar technique, while ensuring that the top surfaces 270 containing the individual elements are themselves aligned mechanically, acoustically, and electrically with each other. The good section 252 may be temporarily fixed in place to allow for a preliminary alignment operation. In one embodiment, such an alignment operation may comprise the actions of inserting the good section 252 and the undamaged section 214 of the recipient array 210 into a jig or form having the general shape and profile of an operational array configuration. Such an operation may permit physical alignment of the elements from the good section 252 and the undamaged section 214 of the recipient array 210. The good section 252 and the undamaged section 214 of the recipient array 210 may then be permanently set in place by the use of a bonding agent or some other agent that may affix the two sections together into a monolithic array and fill the area between the two sections so that the alignment may be maintained. In another embodiment, the good section 252 may be more rigidly “tacked” to the undamaged section 214 of the recipient array 210 by a discrete number of bonding agent portions, so that the repaired array 260 may be removed from the form, electrically connected to test instrumentation (as by wiring harnesses, for example), and adjusted to ensure that the elements are electrically, acoustically, and physically aligned. When such alignment is established, the sections may be permanently affixed to one another according to the previously described procedure. In still another embodiment, the use of the jig or form may be omitted and physical alignment accomplished by visual and manual means. The number of elements in the good section 252 may be chosen so that, after installation, the total number of elements in the repaired array 260 is identical to its original number of elements before the repair process was initiated.

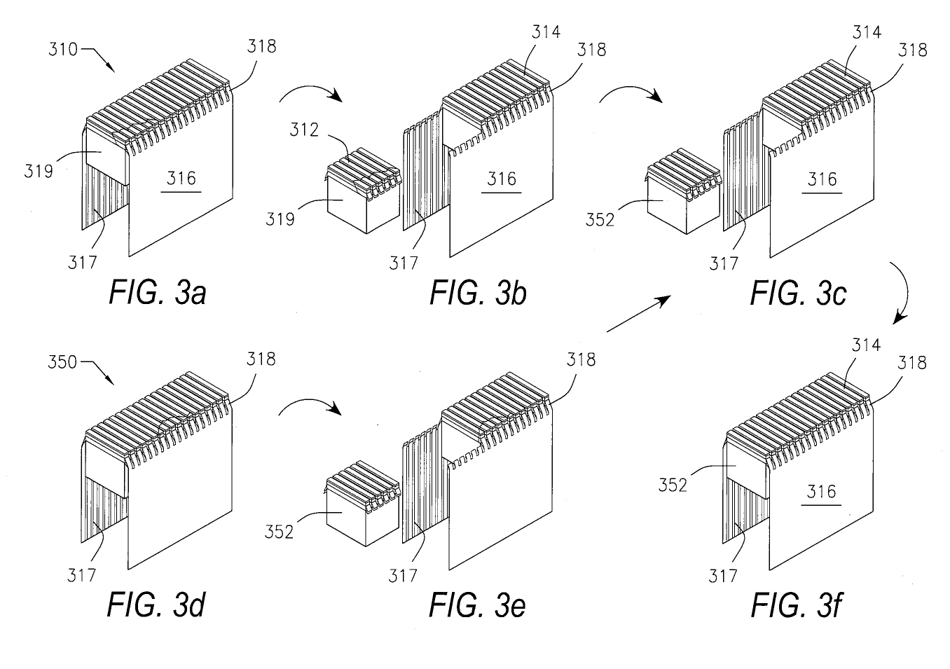

Referring now to FIG. 3, another embodiment of the repair process may be illustrated, in which the flexes remain in place on the recipient array during the removal of the damaged section and on the donor section. According to FIG. 3a, a damaged recipient array 310 is shown with damage indicated by a jagged line across the top of the recipient array 310. The recipient array 310 may have attached to the sides of the array a pair of flexes 316, with traces 317 on the flexes 316 electrically connected, as by surface mount soldering, for example, to leads 318 extending from elements of the recipient array 310. It should be noted that, although the damage is shown as adjacent to an end of the recipient array 310, the position of the damage is shown for illustrative purposes only, and it may be located anywhere along the array and still be within the scope and intent of the present disclosure.

A damaged section 312 may be identified for replacement by a good portion of a donor array 350 (FIG. 3d). The damaged section 312 may comprise a number of contiguous array elements, each of which may be either damaged or undamaged elements. Once the damaged section 312 is identified, then it may be removed from the recipient array 310 leaving a recipient array part 314 consisting of undamaged array elements. This may be accomplished by physically severing the leads 318 from the traces 317 adjacent to the respective elements in the damaged section 312, leaving a portion of each lead 318 intact for later reattachment. The damaged section 312 may be removed from the recipient array (FIG. 3b) along with a portion of the backing 319, so that alignment of the array elements relative to each other may be maintained within the damaged section 312. The recipient array part 314 may then be prepared to receive a donor section 352. Such preparation activities may comprise such actions as smoothing the vertical plane of the recipient array part 314 against which the donor section 352 will abut, grinding away any portions of array elements that may have been damaged by the removal actions of the damaged section 312, and the like; other preparation actions may be taken as appropriate and remain within the scope of the present disclosure.

A donor section 352 may be identified within the donor array 350 (FIG. 3e). The donor section 352 may comprise a number of contiguous array elements, where each array element is functional and capable of normal operation. Note that although the donor section 352 is shown to be positioned at an end of the donor array 350, the donor section 352 may be at any location within the donor array 350 and still be within the scope of the present disclosure. Note also that the number of elements chosen for the donor array 350 may be at least as many as the number of elements contained in the removed damaged section 312 and any elements that may be damaged during the removal operation. The removal of the donor section 352 may comprise removal actions similar to those employed to remove the damaged section 312. Also, the donor section 352 may then be prepared for insertion into the recipient array part 314. Such preparation activities may comprise such actions as smoothing the vertical plane of the donor section 352 and grinding away any portions of array elements that may have been damaged by the removal of the donor section 352 from the donor array 350. The intent of such preparation activities, both for the recipient array part 314 and the donor section 352, may be to ensure that there are no projections or protuberances along the surfaces of either part that may prevent the alignment of the elements of the donor section 352 with those of the recipient array part 314. After removal, the donor section 352 may also be tested to ensure that the array elements remain functional and capable of normal operation.

The donor section 352 may be inserted within and against the recipient array part 314 (FIG. 3c). The donor section 352 may be temporarily fixed in place to allow for a preliminary alignment operation. In one embodiment, such an alignment operation may comprise the actions of inserting the donor section 352 and the recipient array part 314 into a jig or form having the general shape and profile of an operational array configuration. Such an operation may permit physical alignment of the elements from the donor section 352 and recipient array part 314. The donor section 352 and the recipient array part 314 may then be permanently set in place by the use of a bonding agent or some other agent that may affix the two sections together into a monolithic array and fill the area between the two sections so that the alignment may be maintained. In another embodiment, the donor section 352 may be more rigidly “tacked” to the recipient array part 314 by a discrete number of bonding agent portions, so that the repaired array may be removed from the form, electrically connected to test instrumentation (as by wiring harnesses, for example), and adjusted to ensure that the elements are electrically, acoustically, and physically aligned. When such alignment is established, the sections may be permanently affixed to one another according to the previously described procedure. In still another embodiment, the use of the jig or form may be omitted and physical alignment accomplished by visual and manual means.

As shown in FIG. 3f, the leads 318 may be connected back with the traces 317 of the flexes 316. This operation may vary depending upon the methods employed. In one embodiment, a solder bridge may be established between respective lead and trace combinations by using standard surface mount soldering means. In another embodiment, a conductive foil may be taped across all junctions between leads and traces, and the foil may be separated between the lead and trace combinations to isolate them from one another. Other methods of reattaching the respective leads and traces may be used without departing from the scope of the present disclosure.

Referring now to FIG. 4, a generic handheld probe 400 may be illustrated to accompany the description of an embodiment of the disclosed method that may be used for the repair of an acoustic stack 415 used with such devices. The probe is shown in front view 410 (FIG. 4b and FIG. 4d) and side view 420 (FIG. 4a and FIG. 4c), with cutaway portions illustrating the internal structure and orientation of its components. The probe 400 may be used by an operator to easily manipulate the acoustic stack 415 and provide an interface between the acoustic stack and other electronic systems. The elements may be mounted along the top surface of a backing 439, each element comprising a piezoelectric crystal 436 and one or more matching layers 434. The elements may be protectively covered by a lens 432 that extends through a conforming hole in a nosepiece 422 of the probe 400. A lead may extend from either side of the piezoelectric crystal 436, to be attached to a flex circuit 438 or other electrical connection. The flex circuit 438 may extend from the acoustic stack 415 downwardly through the probe 400 to the lower end, where it connects to a cable 426 extending downwardly and away from the probe 400. The probe 400 may be enclosed in a protective casing 424 used to maintain all components in proper orientation and to protect them from damage. In addition, gaps within the protective casing 424 may be filled with potting material in order to mechanically stabilize the internal components of the probe. Repair of a damaged acoustic stack 415 may require that the acoustic stack 415 be removed from this or a similar device in order to gain access to the acoustic stack 415.

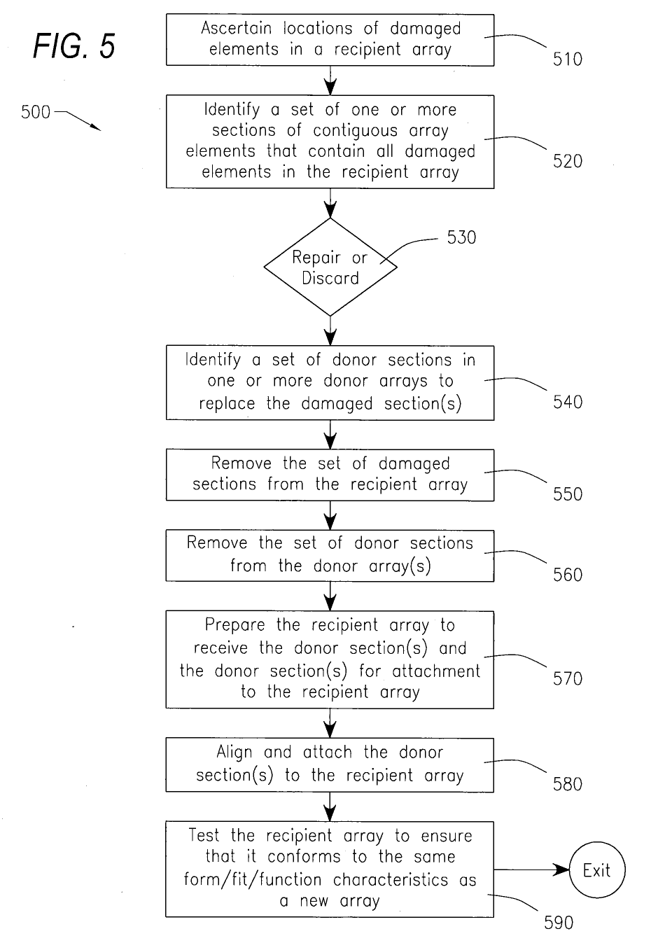

Referring now to FIG. 5, a flowchart 500 is shown for a repair process for acoustic stacks, according to one embodiment disclosed herein. According to the flowchart, a recipient array may be received as a candidate for the disclosed repair process. The repair personnel may examine the candidate recipient array to ascertain the locations of all damaged elements in the array, according to the block designated as 510. This may involve subjecting the candidate array to a series of tests to determine which elements are damaged and the extent of the damage. Criteria may be established to decide whether or not the element is considered to be damaged, and, if the element does not meet the criteria, the element may be identified as a damaged element.

The candidate array may be considered as a unit and a set of damaged sections of the array may be identified according to a set of repair criteria, according to the block designated as 520. The set of damaged sections may be established by numerous methods. One such method would be to assign each damaged element to a damaged section containing only that damaged element. Then sections that are contiguous may be combined to reduce the number of damaged sections. Then, if two adjacent damaged sections are separated by N good elements therebetween (where N is a criterion for repair), then those adjacent damaged sections along with any intervening undamaged elements may be combined into a single section containing both damaged and undamaged elements, all of which are contiguous. The process may continue until a limit is reached, e.g. the number of sections equals one and the section does not comprise the entire array. Other methods may be contemplated without departing from the scope of the present disclosure.

A determination may be made as to whether the candidate array is to be repaired or discarded, according to the block labeled 530. Another criterion may be established to make this determination. For example, the criterion may be that if the number of elements contained in the set of damaged sections is greater than one half the number of elements in a good array, then the array would be discarded or used as another donor array for the repair of other recipient arrays. As another example, if the number of damaged sections in the set is less than the value of M (where M is a second criterion for repair, which may or may not be equal to N), then the candidate array may be designated as repairable. Other criteria may be used to make the determination without departing from the scope of the present disclosure.

If the determination is made to repair the candidate array, then it becomes a recipient array. A set of donor sections from one or more donor arrays for use as candidates for replacing the damaged sections may be identified within a stock of donor arrays that are on-hand, according to the block labeled 540. The repair facility within which the repair is made may have a collection of new and/or damaged arrays from which donor sections containing only good elements may be identified and removed. Occasionally, a completely new array may be ordered from the original equipment manufacturer for use as a donor array. Each donor section thus selected may be matched with a corresponding damaged section, so that the number of elements in the donor section is greater than or equal to the number of elements in the corresponding damaged section. This limitation may allow the number of elements in the good donor sections to be reduced, as by removal and discarding, so that the total number of active array elements in a repaired array is the same as the total number of active array elements in a new array.

The damaged sections may be removed from the recipient array, according to the block designated as 550. Removal may be accomplished with or without the prior removal of flex circuits attached to the array. The designated donor sections may be removed from the one or more donor arrays, according to the block designated as 560. The remaining portions of the recipient array and each of the donor sections may be prepared so that the donor sections may be inserted into and/or affixed to the remaining recipient array, according to the block designated as 570.

The donor sections may be aligned with the elements of the recipient array and attached thereto, according to the block designated as 580. Alignment may be accomplished either manually through use of forms or jigs, or electrically through use of test instrumentation, or through other means within the scope of the present disclosure. When the array has been thus repaired, it may be assembled back into the probe from which it originated, and the probe along with the array may be further tested, according to the block designated as 590. Such testing may ensure that the probe, and thus the array, is a valid form/fit/function repair for the original equipment manufacturer's probe/array. If the repair is not valid, the repair process as shown in FIG. 5 may be repeated.

The present disclosure has been described with reference to flowchart illustrations and/or block diagrams of methods and apparatus (systems), according to embodiments disclosed herein. It will be understood that each block of the flowchart illustrations and/or block diagrams, and combinations of blocks in the flowchart illustrations and/or block diagrams, can be implemented in any order that accomplishes the goal of restoring an acoustic array to normal operation. The present disclosure is not necessarily limited to the steps in the order as presented, but should be construed to include all reasonable variations of step order that accomplish the desired goal.

From the foregoing, it will be understood by persons skilled in the art that a method for the repair of an ultrasound probe device has been provided. While the description contains many specifics, these should not be construed as limitations on the scope of the present disclosure, but rather as an exemplification of the preferred embodiments thereof. The foregoing is considered as illustrative only of the principles of the present disclosure. Further, because numerous modifications and changes will readily occur to those skilled in the art, it is not desired to limit the present disclosure to the exact methodology shown and described, and accordingly all suitable modifications and equivalents may be resorted to, falling within the scope of the present disclosure. Although this disclosure has been described in its preferred form with a certain degree of particularity, it is understood that the present disclosure of the preferred form has been made only by way of example and numerous changes in the details of the method may be resorted to without departing from the spirit and scope of the present disclosure.

We claim:

1. A method for the repair of a damaged ultrasound array, the array comprising elements, the method comprising
identifying a first section of elements in the damaged array, wherein the first section contains a first number of contiguous elements and all damaged elements in the damaged array are in the first section;
identifying a second section in a donor array, the second section having a second number of contiguous good elements that is not less than the first number;
removing the first section from the damaged array to leave one or more repair sites within the damaged array;
removing the second section from the donor array; and
affixing the second section to the repair site of the damaged array.

2. The method described in claim 1, wherein the first section is removed from the damaged array by a process selected from a group consisting of cutting, milling, machining, and sawing.

3. The method described in claim 1, further including
preparing the repair site to receive the second section; and
preparing the second section for affixing onto the repair site,
wherein the repair site and the second section are adjusted so that, after installation, the number of good elements in the damaged array is the same as the number of elements in the damaged array before the repair was accomplished.

4. The method described in claim 3, wherein preparing the second section includes
machining the second section to have a profile that mates to the profile of the repair site.

5. The method described in claim 1, wherein affixing the second section to the repair site of the damaged array includes
attaching the second section to the repair site; and
aligning the elements of the second section with remaining elements in the damaged array.

6. The method described in claim 1, further including
repairing electrical connections to the second section;
reassembling the lens and enclosure; and
testing the array for proper operation.

7. The method described in claim 5, wherein attachment of the second section to the repair site is accomplished through use of a bonding agent.

8. A method for the repair of a damaged array, the array comprising elements, the method comprising
determining a first section of the damaged array within which all of the damaged elements may be located;
removing the first section of the damaged array containing the damaged elements to create a repair site having a profile;
providing a donor array;
identifying a second section of the donor array having a number of undamaged elements equal to the number of damaged elements contained in the first section of the damaged array;
removing the second section from the donor array;
preparing the second section from the donor array to have a profile that mates to the profile of the repair site;
attaching the second section from the donor array to the damaged array at the repair site;
aligning the elements of the second section with the remaining elements in the damaged array;
repairing electrical connections between the second section and the array; and
testing the array for proper operation.

9. A repaired acoustic array of a selected array type, the array containing elements arranged according to a profile and configuration of the array type, the repaired acoustic array comprising
a first portion comprising one or more good elements from a damaged array having the selected array type; and
a second portion comprising one or more good elements from a donor array having the selected array type,
wherein the portions are affixed together in an array having a profile and configuration conforming to a new operational array of the selected array type, the repaired acoustic array being formed by
identifying a first section of elements in the damaged array, wherein the first section contains a first number of contiguous elements and all damaged elements in the damaged array are in the first section;
identifying a second section of elements in the donor array, wherein the second section contains a number of contiguous good elements that is not less than the first number;
removing the first section from the damaged array to leave a repair site within the damaged array;
removing the second section from the donor array;
affixing the second section to the repair site; and
aligning the second section with the remaining elements in the damaged array according to the profile and configuration of the selected array type.

10. The repaired acoustic array described in claim 9, wherein the first section is removed from the damaged array by a process selected from a group consisting of cutting, milling, machining, and sawing.

11. The repaired acoustic array described in claim 9, wherein the repaired acoustic array is further formed by
preparing the repair site to receive the second section; and
preparing the second section for affixing onto the repair site;
wherein the repair site and the second section are adjusted so that, after being affixed, the number of good elements in the damaged array is the same as the number of elements in the damaged array before the repair was accomplished.

12. The repaired acoustic array described in claim 11, wherein preparing the second section for affixing onto the repair site includes
machining the second section to have a profile that mates to the profile of the repair site.

13. The repaired acoustic array described in claim 9, wherein the repaired acoustic array is further produced by
repairing electrical connections to the second section; and
testing the array for proper operation.

14. The repaired acoustic array described in claim 9, wherein the second section is affixed to the repair site through use of a bonding agent.

15. A method for the repair of a damaged ultrasound array, the array comprising elements, the method comprising
identifying a first section of elements in the damaged array, wherein the first section contains a first number of contiguous elements and all damaged elements in the damaged array are in the first section;
identifying a second section in a donor array, the second section having a sufficient number of good elements to make the damaged array operable and useful;
removing the first section from the damaged array to leave one or more repair sites within the damaged array;
removing the second section from the donor array; and
affixing the second section to the repair site of the damaged array.

16. The method described in claim 15, wherein the first section is removed from the damaged array by a process selected from a group consisting of cutting, milling, machining, and sawing.

17. The method described in claim 15, further including
preparing the repair site to receive the second section; and
preparing the second section for affixing onto the repair site,
wherein the repair site and the second section are adjusted so that, after installation, the number of good elements in the damaged array is sufficient to make the damaged array operable and useful.

18. The method described in claim 17, wherein preparing the second section includes
machining the second section to have a profile that mates to the profile of the repair site.

19. The method described in claim 15, wherein affixing the second section to the repair site of the damaged array includes
attaching the second section to the repair site; and
aligning the elements of the second section with remaining elements in the damaged array.

20. The method described in claim 15, further including
repairing electrical connections to the second section; and
testing the array for proper operation.

21. The method described in claim 19, wherein attachment of the second section is accomplished through use of a bonding agent.
